(19) United States
(12) Patent Application Publication
(10) Pub. No.: US 2007/0143364 A1
(43) Pub. Date: Jun. 21, 2007

(54) Techniques to manage contact information

(76) Inventors: Lang S. Chen, Oakland, CA (US); Peter Skillman, San Carlos, CA (US); David G. Champlin, Menlo Park, CA (US); Robert Haitani, Menlo Park, CA (US); Tina Tseng, San Jose, CA (US); Srikiran Prasad, Cupertino, CA (US)

Correspondence Address: KACVINSKY LLC;C/O INTELLEVATE, P.O. BOX 52050, MINNEAPOLIS, MN, 55402, US

(21) Appl. No.: 11/316,280

(22) Filed: Dec. 21, 2005

(51) Int. Cl. G06F 17/30

(52) U.S. Cl. 707/203

(57) ABSTRACT

Techniques to manage contact information are described. An apparatus may comprise a mobile computing device. The mobile computing device may include a contact database management module to dynamically associate different sets of contact information with different contact information databases based on changes in a contact value parameter for each set of contact information. Other embodiments are described and claimed.

### BACKGROUND

A mobile computing device such as a smart phone may have voice and data communications capabilities as well as processing capabilities. The processing capabilities may allow a mobile computing device to store and execute a number of application programs, such as a personal information manager (PIM) application, for example. A PIM may comprise software to manage contact information for multiple entities. For example, a user may use the PIM to search for a telephone number in order to initiate a telephone call. As memory resources for mobile computing devices increase, however, the volume of contact information stored by the PIM application may increase as well. Consequently, this may increase the amount of time needed to retrieve certain contact information from the personal information manager. Accordingly, there may be a need for improved techniques to solve these and other problems.

### BRIEF DESCRIPTION OF THE DRAWINGS

FIG. 1 illustrates one embodiment of a communications system.

FIG. 2 illustrates one embodiment of a mobile computing device.

FIG. 3 illustrates one embodiment of a radio sub-system.

FIG. 4 illustrates one embodiment of a processing sub-system.

FIG. 5 illustrates one embodiment of a contact management module.

FIG. 6 illustrates one embodiment of a logic diagram.

### DETAILED DESCRIPTION

Various embodiments may be directed to techniques for managing contact information. In one embodiment, for example, a mobile computing device may include a contact management module to manage contact information for the mobile computing device. The contact management module may be arranged to operate with a PIM application or by itself. The contact management module may include a contact database management module and a contact information search module. The contact database management module may dynamically associate different sets of contact information with different contact information databases based on changes in a contact value parameter maintained for each set of contact information. The contact information search module may search the different contact information databases in a predefined search order in order to locate a given set of contact information. As a result, the contact management module may potentially reduce the amount of time needed to retrieve a given set of contact information, particularly from larger data sets. Other embodiments are described and claimed.

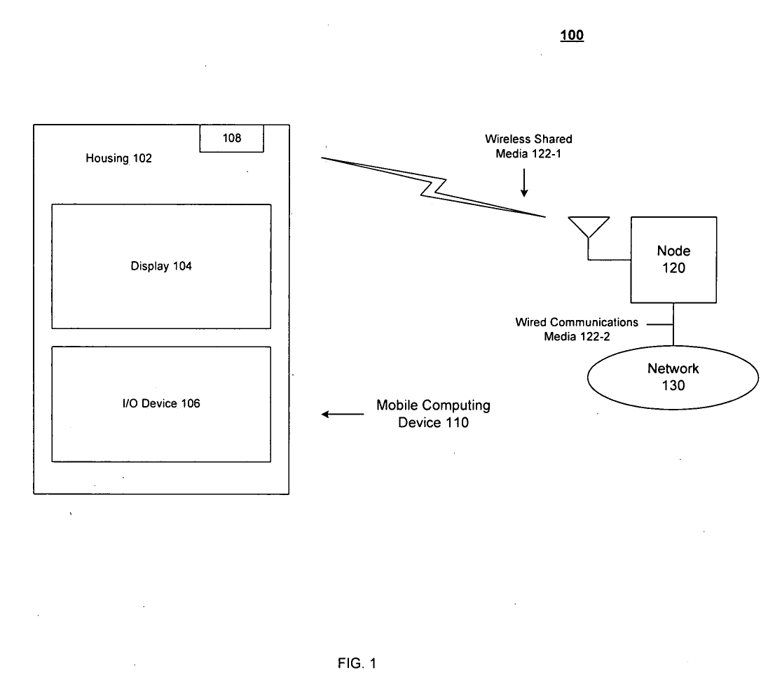

FIG. 1 illustrates one embodiment of a communications system 100. In various embodiments, communications system 100 may be implemented as a wireless communication system, a wired communication system, or a combination of both. When implemented as a wireless communication system, communications system 100 may include components and interfaces suitable for communicating over wireless shared media 122-1, such as one or more antennas, transmitters, receivers, transceivers, amplifiers, filters, control logic, and so forth. An example of wireless shared media 122-1 may include portions of a wireless spectrum, such as the RF spectrum and so forth. When implemented as a wired communications system, communications system 100 may include components and interfaces suitable for communicating over wired communications media 122-2, such as input/output (I/O) adapters, physical connectors to connect the I/O adapter with a corresponding wired communications medium, a network interface card (NIC), disc controller, video controller, audio controller, and so forth. Examples of wired communications media 122-2 may include a wire, cable, metal leads, printed circuit board (PCB), backplane, switch fabric, semiconductor material, twisted-pair wire, co-axial cable, fiber optics, and so forth. The embodiments are not limited in this context.

In various embodiments, communications system 100 may include a mobile computing device 110. Mobile computing device 110 may comprise any device having a processing system and a portable power source (e.g., a battery). Examples of a mobile computing device may include a computer, laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device may also include computers that are arranged to be worn by a person, such as a wrist computer, finger computer, ring computer, eyeglass computer, belt-clip computer, arm-band computer, shoe computers, clothing computers, and other wearable computers. In one embodiment, for example, mobile computing device 110 may be implemented as a smart phone having both wireless voice and/or data communications capabilities, as well as processing capabilities. Although some embodiments may be described with mobile computing device 110 implemented as a smart phone by way of example, it may be appreciated that other embodiments may be implemented using other mobile computing devices as well. The embodiments are not limited in this context.

As shown in FIG. 1, mobile computing device 110 may comprise a housing 102, a display 104, an input/output (I/O) device 106, and an antenna 108. Display 104 may comprise any suitable display unit for displaying information appropriate for a mobile computing device. I/O device 106 may comprise any suitable I/O device for entering information into a mobile computing device. Examples for I/O device 106 may include an alphanumeric keyboard, a numeric keypad, a touch pad, input keys, buttons, switches, rocker switches, microphones, audio interfaces, video interfaces, and so forth. The embodiments are not limited in this context.

In one embodiment, communications system 100 may include a wireless device 120. Wireless device 120 may comprise, for example, a mobile or fixed wireless device. In one embodiment, for example, wireless device 120 may comprise a fixed wireless device operating as an access point for a network or communications system, such as a cellular radiotelephone communications system, a wireless local area network (WLAN), a wireless metropolitan area network (WMAN), a wireless wide area network (WWAN), and so forth. Examples for wireless device 120 may include a wireless access point, base station or device B, base station radio/transceiver, router, switch, hub, gateway, and so forth. In one embodiment, for example, wireless device 120 may comprise a base station for a cellular radiotelephone communications system. Although some embodiments may be described with wireless device 120 implemented as a base station by way of example, it may be appreciated that other embodiments may be implemented using other wireless devices as well. The embodiments are not limited in this context.

In one embodiment, mobile computing device 110 and wireless device 120 may comprise part of a cellular radiotelephone system. Examples of cellular radiotelephone systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, mobile computing device 110 and wireless device 120 may be arranged to perform data communications using any number of different wireless protocols over wireless shared media 122-1. In one embodiment, for example, mobile computing device 110 and wireless device 120 may be arranged to perform data communications using any number of different WWAN data communication services. Examples of cellular data communication systems offering WWAN data communication services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth. In one embodiment, for example, mobile computing device 110 and wireless device 120 may also be arranged to communicate using a number of different WLAN data communication services. Examples of suitable WLAN data communication services may include the Institute of Electrical and Electronics Engineers (IEEE) 802.xx series of protocols, such as IEEE 802.11 a/b/g/n, IEEE 802.16, IEEE 802.20, and so forth. In one embodiment, for example, mobile computing device 110 and wireless device 120 may be further arranged to communicate using a number of shorter range wireless protocols, such as a wireless personal area network (PAN) protocols, an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electromagnetic induction (EMI) techniques. An example of EMI techniques may include passive or active radio-frequency identification (RFID) protocols and devices. The embodiments are not limited in this respect.

In one embodiment, communications system 100 may include network 130 connected to wireless device 120 by wired communications medium 122-2. Network 130 may comprise additional devices and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. In one embodiment, for example, network 130 may be arranged to communicate information in accordance with one or more Internet protocols as defined by the Internet Engineering Task Force (IETF), such as the Transmission Control Protocol/Internet Protocol (TCP/IP), for example. Network 130 may also include other cellular radio telephone system infrastructure and equipment, such as base stations, mobile subscriber centers, central offices, and so forth. The embodiments are not limited in this context.

In general operation, mobile computing device 110 may be capable of storing and executing a number of application programs. One example of an application program may include a PIM application. A PIM application may manage contact information for multiple entities. For example, a user may use the PIM application to search for contact information such as a telephone number in order to initiate a telephone call. The amount of contact information managed by the PIM application, however, is typically limited to a personal contact list maintained by the PIM application. Consequently, the data set for a personal contact list is typically on the order of hundreds of records. Accordingly, searching for a desired set of contact information may be manageable with these relatively smaller data sets, although with marginally acceptable response times.

Recent development of ubiquitous network services such as the Internet, however, has led to the availability of electronic databases having larger volumes of contact information in electronic form. Examples of such databases may include commercial databases, business databases, private databases, personal databases, white page databases, yellow page databases, alumni databases, corporate databases, social relationship databases, and so forth. A user may download the larger databases from network 130, thereby making them locally available to a user of mobile computing device 110. As a result, mobile computing device 110 may potentially increase a size for its contact information database from hundreds of contact information records to thousands of contact information records or more. The response times associated with searching a larger contact information database, however, may increase as the size of the contact information database increases. Consequently, the availability of larger contact information databases may cause a corresponding increase in the amount of time needed for a PIM application to retrieve a particular set of contact information.

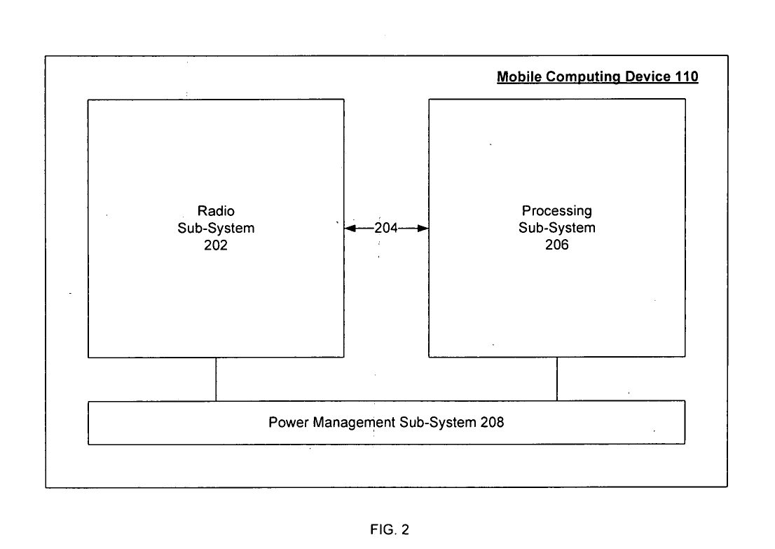

In order to decrease search times, mobile computing device 110 may use improved techniques to manage and search for contact information. In one embodiment, for example, mobile computing device 110 may include a contact management module (CMM). The CMM may include a contact database management module (CDMM) and a contact information search module (CISM). The CDMM may be arranged to maintain multiple contact information databases for mobile computing device 110. More particularly, the CDMM may dynamically associate different sets of contact information with different contact information databases based on changes in a contact value parameter maintained for each set of contact information. The CISM may be arranged to search the different contact information databases in a predefined search order in order to locate a given set of contact information. In this manner, a user may locate and retrieve specific contact information faster than conventional techniques, which may be particularly important as the volume of contact information stored by mobile computing device 110 increases. Mobile computing device 110 in general, and the CMM in particular, may be described in more detail with reference to FIGS. 2-6.

FIG. 2 illustrates one embodiment a mobile computing device. FIG. 2 illustrates a more detailed block diagram of mobile computing device 110 as described with reference to FIG. 1. As shown in FIG. 2, mobile computing device 110 may comprise multiple elements. Although FIG. 2 shows a limited number of elements in a certain topology by way of example, it can be appreciated that more or less elements in any suitable topology may be used in mobile computing device 110 as desired for a given implementation. Furthermore, any element as described herein may be implemented using hardware, software, or a combination of both, as previously described with reference to device implementations. The embodiments are not limited in this context.

In various embodiments, mobile computing device 110 may include a radio sub-system 202 connected via bus 204 to a processing sub-system 206. Radio sub-system 202 may perform voice and data communications operations using wireless shared media 122-1 for mobile computing device 110. Processing sub-system 206 may execute software for mobile computing device 110. Bus 204 may comprise a USB or micro-USB bus and appropriate interfaces, as well as others.

In various embodiments, mobile computing device 110 may also include a power management sub-system 208. Power management sub-system 208 may manage power for mobile computing device 110, including radio sub-system 202, processing sub-system 206, and other elements of mobile computing device 110. For example, power management sub-system 208 may include one or more batteries to provide direct current (DC) power, and one or more alternating current (AC) interfaces to draw power from a standard AC main power supply. The embodiments are not limited in this context.

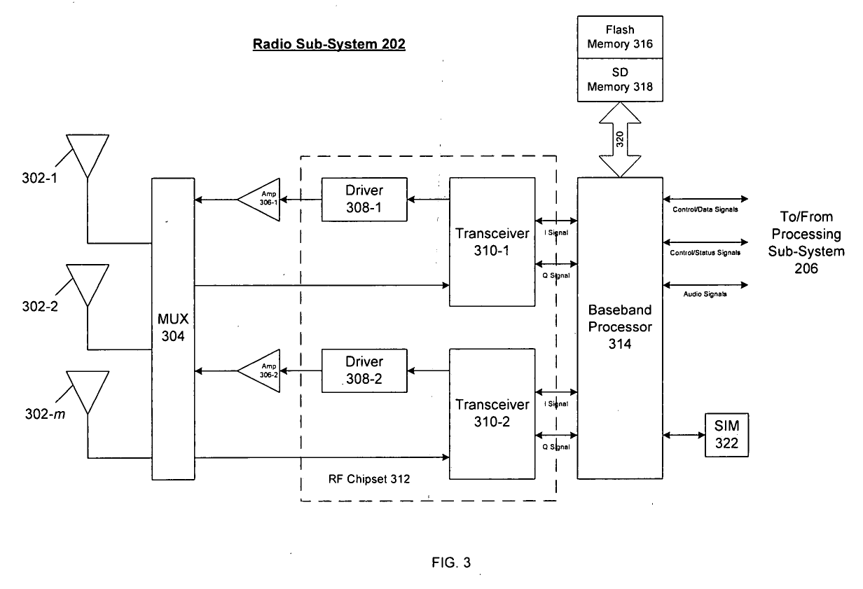

FIG. 3 illustrates one embodiment a radio sub-system. FIG. 3 illustrates a more detailed block diagram of radio sub-system 202 as described with reference to FIG. 2. Radio sub-system 202 may perform voice and data communication operations for mobile computing device 110. For example, radio sub-system 202 may be arranged to communicate voice information and control information over one or more assigned frequency bands of wireless shared media 122-1. The embodiments are not meant to be limited, however, to the example given in FIG. 3.

In various embodiments, radio sub-system 202 may include one or more antennas 302-1-m. Antennas 302-1-m may be used for transmitting and/or receiving electrical signals. Examples for antennas 302-1-m may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. During transmission, antennas 302-1-m may accept energy from a transmission line and radiate this energy into space via wireless shared media 122-1. During reception, antennas 302-1-m may gather energy from an incident wave received over wireless shared media 122-1, and provide this energy to a corresponding transmission line. The amount of power radiated from or received by antennas 302-1-m is typically described in terms of gain. Radio sub-system 202 may be implemented using a single antenna 302-1, or using an array of antennas 302-1-m array, such as a quad band antenna array, for example. Multiple antennas may be desirable when implementing spatial diversity and/or Multiple-Input-Multiple-Output (MIMO) systems. The embodiments are not limited in this context.

In various embodiments, antennas 302-1-m may be connected to a multiplexer 304. Multiplexer 304 multiplexes signals from power amplifiers 306-1, 306-2 for delivery to antennas 302-1-m. Multiplexer 304 demultiplexes signals received from antennas 302-1-m for delivery to RF chipset 312. The embodiments are not limited in this context.

In various embodiments, multiplexer 304 may be connected to power amplifiers 306-1, 306-2. Power amplifiers 306-1, 306-2 may be used to amplify any signals to be transmitted over wireless shared media 122-1. Power amplifiers 306-1, 306-2 may work in all assigned frequency bands, such as 4 frequency bands in a quad-band system. Power amplifiers 306-1, 306-2 may also operate in various modulation modes, such as Gaussian Minimum Shift Keying (GSMK) modulation suitable for GSM systems and 8-ary Phase Shift Keying (8-PSK) modulation suitable for EDGE systems. The embodiments are not limited in this context.

In various embodiments, power amplifiers 306-1, 306-2 may be connected to an RF chipset 312. RF chipset 312 may also be connected to multiplexer 304. In one embodiment, for example, RF chipset 312 may comprise one or more transceivers in a transceiver array. For example, RF chipset 312 may include RF drivers 308-1, 308-2 each coupled to RF transceivers 310-1, 310-2, respectively. RF chipset 312 may perform modulation and direct conversion operations required for GMSK and 8-PSK signal types for quad-band E-GPRS radio, for example. RF chipset 312 receives analog I & Q signals from a baseband processor 314, and converts them to an RF signal suitable for amplification by power amplifiers 306-1, 306-2. Similarly, RF chipset 312 converts the signals received from wireless shared media 122-1 via antennas 302-1-m and multiplexer 304 to analog I & Q signals to be sent to baseband processor 314. RF chipset 312 may be implemented using one or more chips as desired for a given implementation. The embodiments are not limited in this context.

In some embodiments, each transceiver 310-1, 310-2 may be arranged to perform data communications in accordance with a different set of wireless communications protocols and techniques. In one embodiment, for example, transceiver 310-1 may be arranged to communicate information in accordance with a first class of wireless communications protocols and techniques that are generally associated with cellular radiotelephone communication systems. Examples of the first class of protocols may include WWAN protocols, such as GSM/GPRS protocols, CDMA/1xRTT protocols, EDGE protocols, EV-DO protocols, EV-DV protocols, HSDPA protocols, and so forth. In one embodiment, for example, transceiver 310-2 may be arranged to communicate information in accordance with a second class of wireless communications protocols and techniques that are generally associated with a computer network. Examples of the second class of protocols may include WLAN protocols, such as one or more of the IEEE 802.xx series of protocols, such as IEEE 802.11 a/b/g/n, IEEE 802.16, IEEE 802.20, and so forth. Other examples of the second class of protocols may include PAN protocols, Infrared protocols, Bluetooth protocols, EMI protocols including passive or active RFID protocols, and so forth. It may be appreciated that although the various protocols have been generally separated into a first class and a second class, it may be appreciated that transceivers 310-1, 310-2 may be arranged to use any type of protocol from either class as desired for a given implementation. It may also be appreciated that although RF chipset 312 is shown with two transceivers 310-1, 310-2 by way of example, RF chipset 312 may be implemented using more or less transceivers as desired for a given implementation. The embodiments are not limited in this respect.

In various embodiments, RF chipset 312 may be connected to baseband processor 314. Baseband processor 314 may perform baseband operations for radio sub-system 202. Baseband processor 314 may comprise both analog and digital baseband sections. The analog baseband section includes I & Q filters, analog-to-digital converters, digital-to-analog converters, audio circuits, and other circuits. The digital baseband section may include one or more encoders, decoders, equalizers/demodulators, GMSK modulators, GPRS ciphers, transceiver controls, automatic frequency control (AFC), automatic gain control (AGC), power amplifier (PA) ramp control, and other circuits. The embodiments are not limited in this context.

In various embodiments, baseband processor 314 may also be connected to one or more memory units via a memory bus 320. In one embodiment, for example, baseband processor 314 may be connected to a flash memory unit 316 and a secure digital (SD) memory unit 318. Memory units 316, 318 may be removable or non-removable memory. In one embodiment, for example, baseband processor 314 may use approximately 1.6 megabytes of static read-only memory (SRAM) for E-GPRS and other protocol stack needs.

In various embodiments, baseband processor 314 may also be connected to a subscriber identity module (SIM) 322. Baseband processor 314 may have a SIM interface for SIM 322. SIM 322 may comprise a smart card that encrypts voice and data transmissions and stores data about the specific user so that the user can be identified and authenticated to the network supplying voice or data communications. SIM 322 may also store data such as personal phone settings specific to the user and phone numbers. SIM 322 can be removable or non-removable. The embodiments are not limited in this context.

In various embodiments, baseband processor 314 may further include various interfaces for communicating with a host processor of processing sub-system 206. For example, baseband processor 314 may have one or more universal asynchronous receiver-transmitter (UART) interfaces, one or more control/status lines to the host processor, one or more control/data lines to the host processor, and one or more audio lines to communicate audio signals to an audio sub-system of processing sub-system 206. The embodiments are not limited in this context.

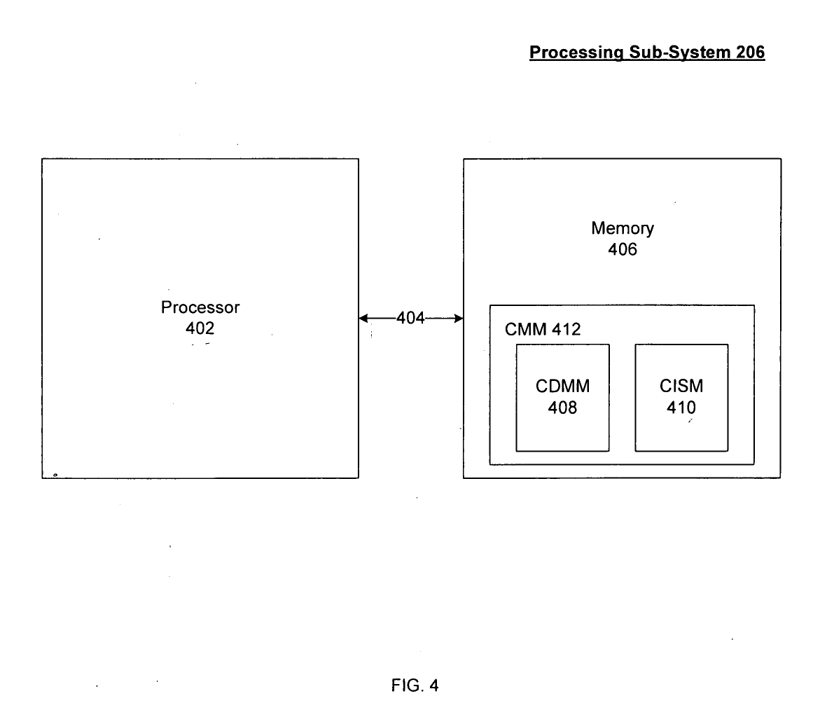

FIG. 4 illustrates one embodiment a processing sub-system. FIG. 4 illustrates a more detailed block diagram of processing sub-system 206 as described with reference to FIG. 2. Processing sub-system 206 may provide computing or processing operations for mobile computing device 110. For example, processing sub-system 206 may be arranged to execute various software programs for mobile computing device 110. Although processing sub-system 206 may be used to implement certain operations for various embodiments as software executed by a processor, it may be appreciated that the operations performed by processing sub-system 206 may also be implemented using hardware circuits or structures, or a combination of hardware and software, as desired for a particular implementation. The embodiments are not limited in this context.

In various embodiments, mobile computing device 110 may be capable of executing various types of software programs using processing sub-system 206. Software programs may be generally grouped into application programs and system programs. Application programs allow a user to accomplish one or more specific tasks. Typical applications include office suites, business software, educational software, databases, communications software, computer games, and so forth. Examples of application programs may include mail programs, web browsers, personal information manager applications, calendar programs, scheduling programs, contact management programs, gaming programs, word processing programs, spreadsheet programs, picture management programs, video reproduction programs, audio reproduction programs, groupware programs, and so forth. Most application software has a graphical user interface (GUI) to communicate information between a device and a user. System programs assists in the running of a computer system. System programs may be directly responsible for controlling, integrating, and managing the individual hardware components of the computer system. Examples of system programs may include operating systems (OS), device drivers, programming tools, utility programs, software libraries, interfaces, program interfaces, API, and so forth.

In various embodiments, processing sub-system 206 of mobile computing device 110 may be capable of executing various types of system programs, such as different OS. In computing, an OS is the system software responsible for the direct control and management of hardware and basic system operations. Additionally, it provides a foundation upon which to run application software such as word processing programs and web browsers. Mobile computing device 110 may utilize any OS suitable for smaller form factor devices, such as a Palm OS®, Palm OS® Cobalt, Microsoft Windows® CE, Microsoft Pocket PC, Symbian OS™, Embedix OS, and others. The embodiments are not limited in this context.

In various embodiments, processing sub-system 206 may include processor 402. Processor 402 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 402 may be implemented as a general purpose processor, such as a processor made by Intel® Corporation, Santa Clara, Calif. Processor 402 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

In one embodiment, processing sub-system 206 may include memory 406 to connect to processor 402. Memory 406 may be implemented using any machine-readable or computer-readable media capable of storing data, including both volatile and non-volatile memory. For example, memory 406 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 406 may be included on the same integrated circuit as processor 402 thereby obviating the need for bus 404. Alternatively some portion or all of memory 406 may be disposed on an integrated circuit or other medium, for example a hard disk drive, that is external to the integrated circuit of processor 402, and processor 402 may access memory 406 via memory bus 404. The embodiments are not limited in this context.

In various embodiments, memory 406 may store one or more software components. A software component may refer to one or more programs, or a portion of a program, used to implement a discrete set of operations. In one embodiment, for example, memory 406 may include one or more software components, such as a contact management module (CMM) 412. CMM 412 may be responsible for certain contact management operations of mobile computing device 110. CMM 412 may include a contact database management module (CDMM) 408 and a contact information search module (CISM) 410. It is worthy to note that although some embodiments may describe these modules as software components executed by processing sub-system 206, it may be appreciated that some or all of the operations of the software components may be implemented using other processors accessible by mobile computing device 110, such as baseband processor 314, for example. Furthermore, these modules may also be implemented using dedicated hardware circuits or structures, or a combination of dedicated hardware and software, as desired for a given implementation. The embodiments are not limited in this context.

In various embodiments, CMM 412 may be integrated with, or form part of, a PIM application (not shown). Examples of a PIM application may include Microsoft® Outlook™, Palm® Contacts, and so forth. The PIM application may maintain separate sets of contact information for various entities (e.g., an individual, group, business, and so forth) using various data structures, such as contact information records with one or more defined fields. The particular type of PIM application used with CMM 412 is not limited in this context. Alternatively, CMM 412 may be independent elements arranged to operate with an existing PIM program. In this case, CMM 412 may have the appropriate interfaces to communicate information with the resident PIM program to implement all or some of the operations described herein. The embodiments are not limited in this context.

In various embodiments, CMM 412 may perform contact management operations for mobile computing device 110. More particularly, CMM 412 may manage contact information for mobile computing device 110. The contact information may include any information used to establish voice and/or data communications between devices. The contact information may include one or more contact identifiers. A contact identifier may be a unique identifier for a device or user. Examples of contact identifiers may include a telephone number, an email address, a network address, an IP address, an IPv4 address, an IPv6 address, a universal resource locator (URL), a domain name, a hardware address (e.g., a media access controller address), voice over IP (VoIP) tags, instant messaging (IM) addresses, Skype accounts, photo tags, location information, and so forth. The embodiments are not limited in this context.

In various embodiments, CDMM 408 may perform various database management operations for CMM 412. In one embodiment, for example, CDMM 408 may store, assign or associate the contact information with various contact information databases. Given the increasing volumes of contact information stored by mobile computing device 110, CDMM 408 may improve management of the volumes of contact information by creating, defining, modifying or updating multiple contact information databases. A contact information database may refer to one or more databases arranged to store a particular type of contact information. For example, a personal contact information database may be created to store contact information for personal friends and family (e.g., a personal contact list, buddy list, and so forth). In another example, a business contact information database may be created to store contact information for a business entity. Other examples of a contact information database may include a personal contact list, a buddy list, a public database, a commercial database, a non-commercial database, a social database, a corporate database, subscriber or fee based databases, and any other resident or network-accessible databases. Examples of a public database may include a yellow page database, a white page database, an area code database, a government database, a census database, a mapping database, and any other publicly available database. Examples of social databases may include school alumni databases, personal network databases, and so forth. A personal networking database may comprise a database where each user may enter a list of names of other linked individuals known to the user, and the personal network database may cross-match the linked individuals to form new relationships between the users sharing a given linked individual. It may be appreciated that these are merely a few examples of a contact information database, and many other contact information databases exist that may be suitable for use with the embodiments as described herein. The embodiments are not limited in this context.

In various embodiments, one or more contact information databases may be stored locally by mobile computing device 110 via memory 406 or SIM 322. For example, a user may periodically download to mobile computing device 110 various commercial databases, such as a yellow pages directory, a white pages directory, an area code directory, and so forth. Furthermore, mobile computing device 110 may use various techniques to optimize search times for the contact information databases, such as loading the contact information database to a non-volatile memory cache during initialization of mobile computing device 110, ordering or indexing the contact information databases based on frequency, creating a cache for recently retrieved contact information or likely retrieved contact information (e.g., business contacts first, personal contacts second), and so forth. Alternatively, the contact information database may also be stored remotely from mobile computing device 110, such as by a web server accessible via network 130. In the latter case, CDMM 408 may query the web server to retrieve the contact information from the remotely stored contact information database via wireless device 120 and network 130.

In various embodiments, CDMM 408 may maintain a contact value parameter for each contact information record. As previously described, CDMM 408 may manage a relatively large volume of contact information. CDMM 408 may create a contact value parameter for each contact information record. The contact value parameter may represent a value for a contact information record relative to the other contact information records within a contact information database. CDMM 408 or a user may explicitly or implicitly define and manage the contact value parameters in accordance with a set of heuristics, statistical assumptions, and/or predefined rules.

In one embodiment, for example, the contact value parameter may be used to implement a set of statistical assumptions or probabilities regarding the relative value of the associated contact information. For example, one assumption may be that contact information that has been frequently accessed on a historical basis may have a higher likelihood or probability of being accessed in the future. Consequently, CDMM 408 may define and use a contact value parameter implemented as a frequency based value. In another example, an assumption may be that contact information that has been recently accessed on a historical basis may have a higher likelihood of being accessed in the future. Consequently, CDMM 08 may define and use a contact value parameter implemented as a time based value. It may be appreciated that the frequency based value assumption and time based value assumption are provided merely as representative examples, and any number of assumptions may be used to define and use a particular contact value parameter. The embodiments are not limited in this context.

In one embodiment, for example, the contact value parameter may reflect one or more user-defined parameters. For example, a user may select certain contact identifiers to have a higher priority level than other contact identifiers, while other contact identifiers may have a lower priority level. In another example, a user may explicitly assign certain contact identifiers to certain contact information databases. The embodiments are not limited in this context.

In various embodiments, CDMM 408 may use the contact value parameters to explicitly or implicitly associate a given set of contact information with a particular contact information database. As previously described, CDMM 408 may be used to create or define different types of contact information databases, such as a personal database, a business database, a personal contact list, a buddy list, a public database, a commercial database, a non-commercial database, a social database, a corporate database, a subscriber database, an incoming communication log database, an outgoing communication log database, time based databases, frequency based databases, and so forth. CDMM 408 or a user may associate each set of contact information with one or more defined contact information databases based on the contact value parameter. For example, the frequency based values and time based values as previously described may be used to store, assign or associate a corresponding set of contact information with a particular contact information database, such as a frequency based database and time based database, respectively. The embodiments are not limited in this context.

In various embodiments, CDMM 408 may dynamically associate or re-associate different sets of contact information with different contact information databases based on changes in the contact value parameter maintained for each set of contact information. In some implementations, the contact value parameter for each set of contact information may be modified. For example, the contact value parameter may change to reflect the number of times a particular contact identifier is accessed if the contact value parameter is a frequency based value. As a contact value parameter changes, CDMM 408 may determine whether to associate the contact information corresponding to the contact value parameter with a different contact information database. For example, CDMM 408 may create a set of frequency based contact information databases of any given level of granularity, such as a high frequency database, a medium frequency database, and a low frequency database. CDMM 408 may move or re-associate a given set of contact information between the various frequency based contact information databases as the contact value parameter changes. In another example, CDMM 408 may create a set of time based contact information databases of any given level of granularity, such as a most recent database, recent database, and least recent database. CDMM 408 may move or re-associate a given set of contact information between the various time based contact information databases as the contact value parameter changes.

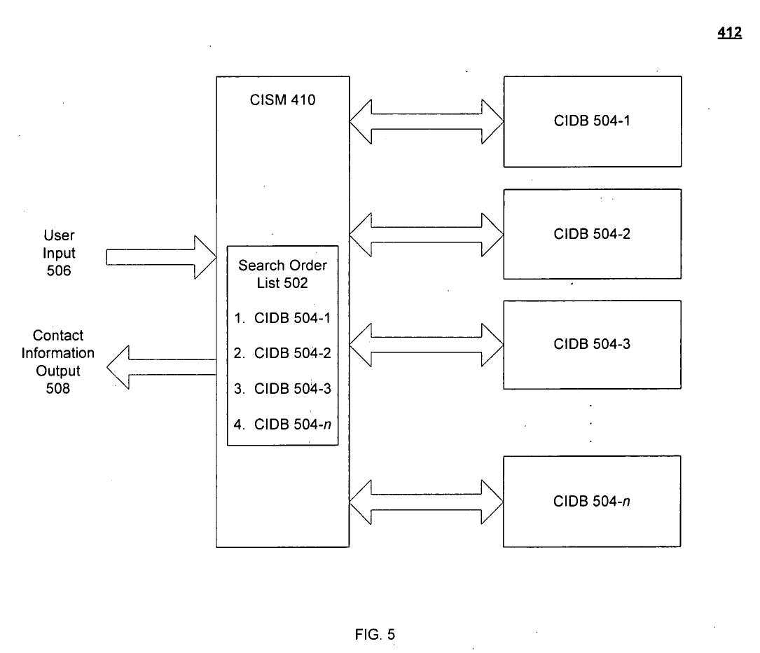

In various embodiments, CISM 410 may be arranged to search for contact information as managed by CDMM 408. CISM 410 may use a contact information search algorithm to search for a given set of contact information or a contact identifier in the multiple contact information databases. CISM 410 may search for the desired contact information using a number of different techniques. In one embodiment, for example, CISM 410 may be arranged to search the different contact information databases in a predefined search order in order to locate a given set of contact information. The search order may be selected by a user or CISM 410 to increase the probability that the contact information will be located. For example, the search order may assume that contact information that has been frequently accessed on a historical basis may have a higher likelihood or probability of being accessed in the future. Consequently, CISM 410 may search a frequency based database before other contact information databases. In another example, the search order may assume that contact information that has been recently accessed on a historical basis may have a higher likelihood of being accessed in the future. Consequently, CISM 410 may search a time based database before other contact information databases. Accordingly, a particular defined search order for the contact information databases available to mobile computing device 110 may reflect a set of assumptions for a given user or device to enhance the probability of decreasing search times for a target set of contact information. CDMM 412 in general, and CISM 410 in particular, may be described in more detail with reference to FIG. 5.

FIG. 5 illustrates one embodiment of a contact management module. FIG. 5 provides a more detailed illustration for CMM 412. As shown in FIG. 5, CISM 410 may include a search order list 502. CISM 410 may receive user inputs 506, and output contact information output 508. CISM 410 may also have access to contact information databases (CIDB) 504-1-n, with n representing any positive integer. CIDB 504-1-n may be implemented as individual databases, or alternatively, as a single database (e.g., a sequel database) with multiple views. CIDB 504-1-n may be stored using memory 406, or may use some other memory available internally or externally to mobile computing device 110.

In general operation, CISM 410 may receive user inputs 506. User inputs 506 may be used to receive information from a user or other elements (e.g., a PIM application) of mobile computing device 110. The information may comprise control information such as one or more operational commands. An example of an operational command may include initiating a search for contact information. The information may also comprise content information that may be used to search for a given set of contact information. For example, the content information may include some or all of a contact name, such as the first few letters of a first name or last name, a first letter of a first name and the first few letters of a last name, and so forth. The particular type of content information used for a search may vary according to a given contact information search algorithm implemented for CMM 412. CISM 410 may receive the user commands and/or content information via user inputs 506, and initiate a search of CIDB 504-1-n using the received content information.

In further operations, CISM 410 may search one or more CIDB 504-1-n using search order list 502. Search order list 502 may comprise a list of contact information databases CIDB 504-1-n to be searched by CISM 410. Furthermore, search order list 502 may include a search order or search sequence in which the particular list of CIDB 504-1-n should be searched by CISM 410. As shown in FIG. 5, search order list 502 may include CIDB 504-1, CIDB 504-2, CIDB 504-3 and CIDB 504-n. Furthermore, search order list 502 may have a search order of 1-4 that corresponds to CIDB 504-1-n, respectively. Consequently, CISM 410 may search for the desired contact information starting with CIDB 504-1, and sequentially move through CIDB 504-2-n, until the desired contact information is located or a terminating condition is reached. Examples of terminating conditions may include searching the last contact information database (e.g., CIDB 504-n) without locating the target set of contact information, expiration of a timer, and so forth. The embodiments are not limited in this context.

The operations of CISM 410 may be further described by way of example. In this example, assume mobile computing device 110 is used primarily for business purposes. Further assume that CIDB 504-1 represents a business contact information database, CIDB 504-2 represents a corporate contact information database, and CIDB 504-3 represents a commercial contact information database. In this example, CIDB 504-n may represent a default database, such as a personal contact list for a PIM application or some other database. In this case, search order list 502 may have a search list and search order as follows: (1) business contact information database; (2) corporate contact information database; (3) commercial contact information database; and (4) default database. CISM 410 may receive user input 506 in the form of content information such as a first letter of a first name and the first few letters of a last name. CISM 410 may initiate a search for the contact information associated with the content information. CISM 410 may conduct search operations in accordance with search order list 502 by starting with the business contact information database. If the relevant contact name is not found in the business contact information database, CISM 410 may next search for the desired contact information using the corporate contact information database, the commercial contact information database, and finally the default database. By conducting the search using search order list 502, CISM 410 may potentially decrease the amount of time needed to retrieve specific contact information using the relatively smaller contact information databases, rather than searching for the specific contact information using a single contact information database storing all possible contact information available on mobile computing device 110.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

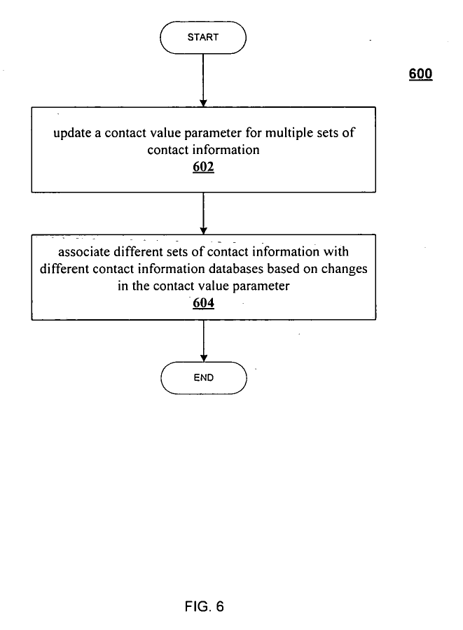

FIG. 6 illustrates one embodiment of a logic flow. FIG. 6 illustrates a logic flow 600. Logic flow 600 may be representative of the operations executed by one or more embodiments described herein, such as mobile computing device 110. As shown in logic flow 600, a contact value parameter may be updated for multiple sets of contact information at block 602. Different sets of contact information may be associated with different contact information databases based on changes in the contact value parameter at block 604. The embodiments are not limited in this context.

In one embodiment, for example, a set of contact information may be associated with a first contact information database based on a contact value parameter. The set of contact information may be associated with a second contact information database when the contact value parameter changes. The embodiments are not limited in this context.

In one embodiment, for example, the different contact information databases may be searched in accordance with a defined search order to locate the contact information. The embodiments are not limited in this context.

In one embodiment, for example, the contact value parameters may be initially defined prior to the updating operations. The embodiments are not limited in this context.

In one embodiment, for example, each set of contact information may be initially associated with one of the contact information databases prior to the associating or re-associating operations. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A mobile computing device, comprising:
a contact database management module to dynamically associate different sets of contact information with different contact information databases based on changes in a contact value parameter for each set of contact information.

2. The mobile computing device of claim 1, said contact database management module to associate a set of contact information with a first contact information database based on a contact value parameter, and associate said set of contact information with a second contact information database when said contact value parameter changes.

3. The mobile computing device of claim 1, comprising a contact search module to search said different contact information databases in accordance with a defined search order to locate said contact information.

4. The mobile computing device of claim 1, said contact value parameter to comprise a frequency based value.

5. The mobile computing device of claim 1, said contact value parameter to comprise a time based value.

6. A system, comprising:
a radio sub-system;
a processing sub-system to connect to said radio sub-system; and
a contact database management module to dynamically associate different sets of contact information with different contact information databases based on changes in a contact value parameter for each set of contact information.

7. The system of claim 6, said contact database management module to associate a set of contact information with a first contact information database based on a contact value parameter, and associate said set of contact information with a second contact information database when said contact value parameter changes.

8. The system of claim 6, comprising a contact search module to search said different contact information databases in accordance with a defined search order to locate said contact information.

9. The system of claim 6, said contact value parameter to comprise a frequency based value.

10. The system of claim 6, said contact value parameter to comprise a time based value.

11. A method, comprising:
updating a contact value parameter for multiple sets of contact information; and
associating different sets of contact information with different contact information databases based on changes in said contact value parameter.

12. The method of claim 11, comprising:
associating a set of contact information with a first contact information database based on a contact value parameter; and
associating said set of contact information with a second contact information database when said contact value parameter changes.

13. The method of claim 11, comprising searching said different contact information databases in accordance with a defined search order to locate said contact information.

14. The method of claim 11, comprising initially defining said contact value parameters.

15. The method of claim 11, comprising initially associating each set of contact information to one of said contact information databases.

16. An article comprising a machine-readable storage medium containing instructions that if executed enable a system to update a contact value parameter for multiple sets of contact information, and associate different sets of contact information with different contact information databases based on changes in said contact value parameter.

17. The article of claim 16, further comprising instructions that if executed enable the system to associate a set of contact information with a first contact information database based on a contact value parameter, and associate said set of contact information with a second contact information database when said contact value parameter changes.

18. The article of claim 16, further comprising instructions that if executed enable the system to search said different contact information databases in accordance with a defined search order to locate said contact information.

19. The article of claim 16, further comprising instructions that if executed enable the system to initially define said contact value parameters.

20. The article of claim 16, further comprising instructions that if executed enable the system to initially associate each set of contact information to one of said contact information databases.
